(19) United States
(12) Patent Application Publication
(10) Pub. No.: US 2011/0067641 A1
(43) Pub. Date: Mar. 24, 2011

(54) Methods and Apparatus For Increasing Upper-Level Fish Populations

(75) Inventor: Philip W. Kithil, Santa Fe, NM (US)

(73) Assignee: ATMOCEAN, INC., SANTE FE, NM (US)

(21) Appl. No.: 12/991,998

(22) PCT Filed: May 18, 2009
(86) PCT No.: PCT/US09/44392

§ 371 Date: Nov. 10, 2010

Related U.S. Application Data
(60) Provisional application No. 61/053,995, filed on May 16, 2008.
(60) Provisional application No. 61/077,012, filed on Jun. 30, 2008.

(51) Int. Cl. A01K 61/00; F03B 13/14

(52) U.S. Cl. 119/215; 417/330; 417/331

(57) ABSTRACT

A method and apparatus for pumping deeper water from a large body of water to an upper portion thereof using wave energy, thereby increasing nutrients at said upper portion and thus the fish populations thereof.

### CROSS-REFERENCE TO RELATED APPLICATIONS

This application claims priority to and the benefit of U.S. patent application Ser. No. 61/077,012, entitled “Wave-Driven Upwelling Pump with Virtual Tube”, filed on Jun. 30 2008, and U.S. Provisional Patent Application Ser. No. 61/053,995, entitled “Wave-Driven Upwelling Pump”, filed on May 16, 2008, both of those applications are related to U.S. patent application Ser. No. 12/056,480, Patent Cooperation Treaty Application No. PCT/US2006/037912, and U.S. Provisional Patent Application Ser. Nos. 60/720,864, and 60/741,006, and the specifications and claims, if any, thereof are incorporated herein by reference.

### STATEMENT REGARDING FEDERALLY SPONSORED RESEARCH OR DEVELOPMENT

Not Applicable

### BACKGROUND OF THE INVENTION

1. Field of the Invention (Technical Field)

Embodiments of the present invention relate to methods and apparatuses for altering conditions in large bodies of water. Embodiments of the present invention also relate to methods, apparatus, and systems for enhancing ocean fish catch; techniques for monetizing the enhanced ocean fish catch; regulatory techniques for sustainable management of the ocean fish resource; methods, apparatus, and alternative designs to release water contained within tube portions of wave-driven pumps; and methods, apparatuses and systems for mixing adjacent parcels of fluid.

2. Description of Related Art

Note that the following discussion refers to a number of publications by author(s) and year of publication, and that due to recent publication dates certain publications are not to be considered as prior art vis-a-vis the present invention. Discussion of such publications herein is given for more complete background and is not to be construed as an admission that such publications are prior art for patentability determination purposes.

U.S. patent application Ser. No. 12/056,480 discloses a spool-shaped buoy to allow the flexible tube to be rolled up for storage and transportation; multiple pumps with tethers to maintain spacing, with the pumps not directly connected to seafloor or land-based anchors; each buoy provided with electronic measuring and communication devices; and the pump operating to bring up deep cold water containing higher nutrients, causing more phytoplankton to grow which increase the ocean food chain, resulting in greater fish populations.

Provisional Patent Application Ser. No. 60/981,699 depicts a similar buoy provided with a vertical axis wind turbine to generate electricity both for local consumption and conveyed via a high voltage direct current conductor to a land power grid. Multiple buoys are connected in series to increase the overall power generation capability.

Previous attempts at moving water from lower portions of a water body to an upper portion thereof via wave action have relied on long flexible plastic tubes to transport the water. Such tubes, however, typically have a single valve disposed at a bottom of the tube. The failure of that single valve will typically render the entire pump inoperable or extremely inefficient. In addition, a large stress is induced on the flexible tube.

The rapid pace of global warming and its effects on the ocean ecosystem are becoming better understood from scientific study. In fact, a substantial majority of the global warming heat imbalance has been absorbed by the oceans, with some recent data suggesting thermal expansion has doubled the sea level rise from previous estimates. In addition, the warming ocean is becoming more stratified, which means less deep nutrients are reaching the upper sunlit zone. This in turn is reducing primary production (phytoplankton) which naturally absorb CO₂ and produce O₂ from the photosynthetic process. Potentially severe feedbacks result as warmer water holds less O₂, compared to colder water, in turn diminishing the size and density, and increasing dispersion, of zooplanktonic swarms, such as krill, which are a primary source of food for higher trophic levels. All of these effects suggest possible cascading harm to ocean life, ultimately risking survival of terrestrial species which rely on ocean life. So clearly, a system is needed which can mix deeper, colder, higher nutrient water into the upper ocean, thereby increasing, at least temporarily, the capacity of the upper ocean to absorb heat from the atmosphere, while enhancing biological activity.

Background information relating to various aspects of embodiments of the present invention can be found in the following:
Bermuda Atlantic Time-series Study. 2003. http://bats.bbsr.edu.
Bundy, A. 2004. Mass balance models of the eastern Scotian Shelf before and after the cod collapse and other ecosystem changes. Can. Tech. Rep. Fish. Aquat. Sci. 2520: xii-193.
Dalsgaard, J. and D. Pauly. 1997. Preliminary mass-balance model of Prince William Sounds, Alaska, for the pre-spill period, 1980-1989. Fisheries Centre Research Report 5, 34 p.
Heymans, J. J. 2001. The Gulf of Maine, 1977-1986. In: Guénette, S., V. Christensen and D. Pauly (eds). Fisheries impacts on North Atlantic ecosystems: models and analyses. FCRR 9: 128-150.
Ho, T.-Y., A. Quigg, Z. V. Finkel, A. J. Milligan, K. Wyman, P. G. Falkowski and F. M. M. Morel. 2003. The elemental composition of some marine phytoplankton. J. Phycol. 39: 1145-1159.
NOAA World Ocean Atlas 2005. http://www.nodc.noaa.gov
Redfield, A. C. 1934. On the proportions of organic derivations in sea water and their relation to the composition of plankton. In: Daniel, R. J. (ed) James Johnson Memorial Volume. University Press of Liverpool, 177-192.
Landry, M. R., J. Constantinou, M. Latasa, S. L. Brown, R. R. Bidigare and M. E. Ondrusek. 2000. Biological response to iron fertilization in the eastern equatorial Pacific (IronEx II), III. Dynamics of phytoplankton growth and microzooplankton grazing. Marine Ecology Progress Series 201: 57-72.
Martin, J. H. 1990. Glacial-Interglacial CO2 change: The iron hypothesis. Paleoceanography 5: 1-13.
Walsh, J. J. 1981. A carbon budget for overfishing off Peru. Nature 290: 300-304.
Weber, L., C. Völker, A. Oschlies and H. Burchard. 2007. Iron profiles and speciation of the upper water column at the Bermuda Atlantic time-series Study site: a model based sensitivity study. Biogeosciences Discuss. 4: 823-869.

### BRIEF SUMMARY OF THE INVENTION

An embodiment of the present invention relates to a method for increasing fish populations which includes providing a wave-driven pump, and pumping water with the wave-driven pump to bring locally-existing nutrients from a deeper layer to an upper layer. The pumping can occur within a large body of water, which can be an ocean. The water can be pumped a distance of at least 100 feet and optionally a distance of at least 600 feet. The method can also include monitoring fish populations around at least an upper portion of the pump using an echolocater, and the echolocater can optionally be disposed on a portion of the pump, which can optionally be the buoy of the pump. The method can also include communicating results of the fish monitoring to a remote location.

An embodiment of the present invention also relates to a wave-driven pump which includes a releasable valve disposed at a lower portion thereof. The valve can optionally be released by a weight sliding down a cable and impacting a portion of said valve, which portion can be a release mechanism. Optionally, the valve of the wave-driven pump can include an assembly which provides a breach within the pump whereby water is released through the breach when the pump is lifted from a body of water. Optionally, the assembly can include an impact-activated release mechanism.

In another embodiment, the present invention relates to an ocean water movement apparatus which includes a plurality of rotatable panels connected to a wave energy capturing apparatus by a cable. The energy capturing apparatus can include a buoy. Optionally, at least some of the rotatable panels can be arranged in pairs and disposed along at least a portion of the cable at spaced intervals. The panels can be positioned on the cable such that a primary axis of the cable forms a substantially right angle with a primary plane of the panels when the panels are in a non-rotated state. The panels can rotate approximately 90 degrees such that a primary axis of the cable is substantially parallel with a primary plane of the panels when the panels are in a rotated state.

Preferably, the water parcels not contiguous to the rotatable panels constrain the movement of water parcels contiguous to the rotatable panels. Movement of the contiguous parcels is preferably substantially vertical. The energy capturing apparatus can also include a cable formed into a loop which is connected to the wave energy capturing device. Optionally, the topmost portion of the cable loop can be movably positionable.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1A is a drawing of a pump according to an embodiment of the present invention wherein a releasable valve is connected thereto;

FIGS. 1B-D are drawings illustrating a releasable valve and components thereof according to an embodiment of the present invention;

FIG. 2 is a drawing illustrating an embodiment of the present invention wherein a pair of panels is attached to a buoy via a cable;

FIG. 3 is a drawing which illustrates directions of travel for water surrounding a pair of panels which are moved to create an upwelling action;

FIG. 4 is a drawing which illustrates a series of panels attached to a cable extending from a buoy;

FIG. 5 is a drawing illustrating the arc path followed by a pair of panels when they pivot;

FIG. 6 is a drawing which illustrates a perspective view of a pair of panels having a lip disposed on an upper surface near a outer circumference thereof;

FIGS. 7A-C are drawings which illustrate embodiments of the present invention wherein different sizes of panels are used;

FIGS. 8A & B are drawings which illustrate an embodiment of the present invention wherein the cable is configured to be rotatable to provide upwelling or downwelling effects; and

FIGS. 9A & B are drawings which illustrate ellipsoidal-shaped panels which cause a weathervane effect on the panel.

### DETAILED DESCRIPTION OF THE INVENTION

As used throughout the specification and claims, the term “cable” is intended to have a broad meaning which includes any device, method, or apparatus capable of transferring a pulling force, including cables, ropes, chains, rods, tubes, straps, wires, strings, belts, combinations thereof, and the like, all made from any type of material capable of maintaining, for at least a limited time, at least some structural integrity when submersed in an aqueous environment.

Ocean fisheries typically are regulated by appropriate governmental authorities, e.g., state rules apply within 3 miles of U.S. shorelines, then U.S. rules apply beyond 3 miles out to 200 miles, and international rules apply beyond 200 miles. Unfortunately the fish are indifferent to these artificial boundaries, since these rules apply to the fisherman and not the fish. One result of this arbitrary boundary system is the widespread mismanagement of ocean fish resources.

Applicant's wave-driven upwelling pump brings up higher-nutrient, deep, ocean water, which in the presence of sunlight generates phytoplankton—the base of the ocean food chain. Assuming Redfield-ratio values for propagation of species in the ocean, and based on a 3 m diameter by 200 m deep pump operating for 30 days in 3 m waves with a period of 10 seconds, consulting biologist Dr. Wiebke Boeing has calculated 124 kg additional fish biomass per month, as follows:

### Redfield Ratio and Solution

Iron (Fe) is typically the limiting nutrient in the oceans (Martin 1990; Landry et al. 2000).

The Redfield ratio for living marine phytoplankton is:

C:N:P:Fe=147:16:1:0.0075 (Redfield 1934; modified by Ho et al. 2003)

This ratio can vary depending on algae composition and seawater chemistry.

Assuming the better scenario of 0.6 nmol Fe*L⁻¹, in the 5.5*10⁹ L that were brought up to the surface we will add 5.5*10⁹*0.6=3,296,246,400 nmol Fe or 3.3 mol Fe to the mixed layer. 3.3 mol Fe will result in an uptake of 3.3*19,600=64,680 mol of Carbon. Carbon has a molar mass of 12 g/mol and, therefore, the uptake would be 64,680*12=776,160 g or 776 kg of Carbon.

### Phytoplankton Biomass

The ratio between wet weight of phytoplankton: carbon is 16 (Walsh 1981) with values ranging between 10 (Dalsgaard and Pauly 1997; Bundy 2004) to 62 (Heymans 2001). Therefore, the wet weight of phytoplankton produced is 776*16=12,416 kg.

With a typical trophic transfer efficiency of 10% and an assumed short food chain (phytoplankton—zooplankton—fish) the additional fish biomass produced would be 124 kg. (References follow).

One issue associated with the installation of such upwelling pumps and the increased fish populations resulting therefrom is how the additional fish production will be regulated at a sustainable pace, given the multiple jurisdictions cited above; and how the upfront and recurring investment in the wave driven pumps that generate this additional fish biomass will be justified, since the rules are unclear and fisherman could catch the fish without paying anything.

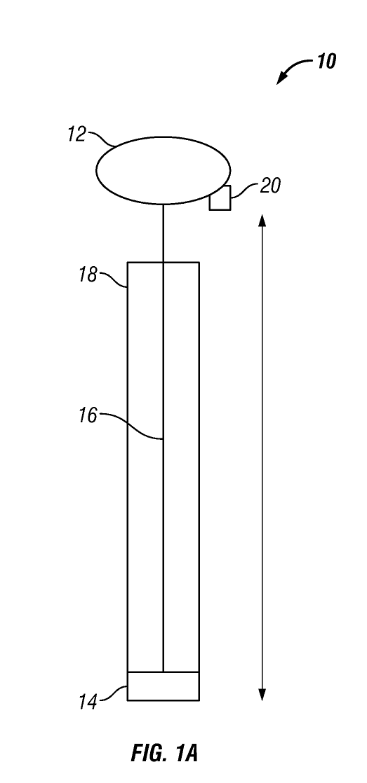

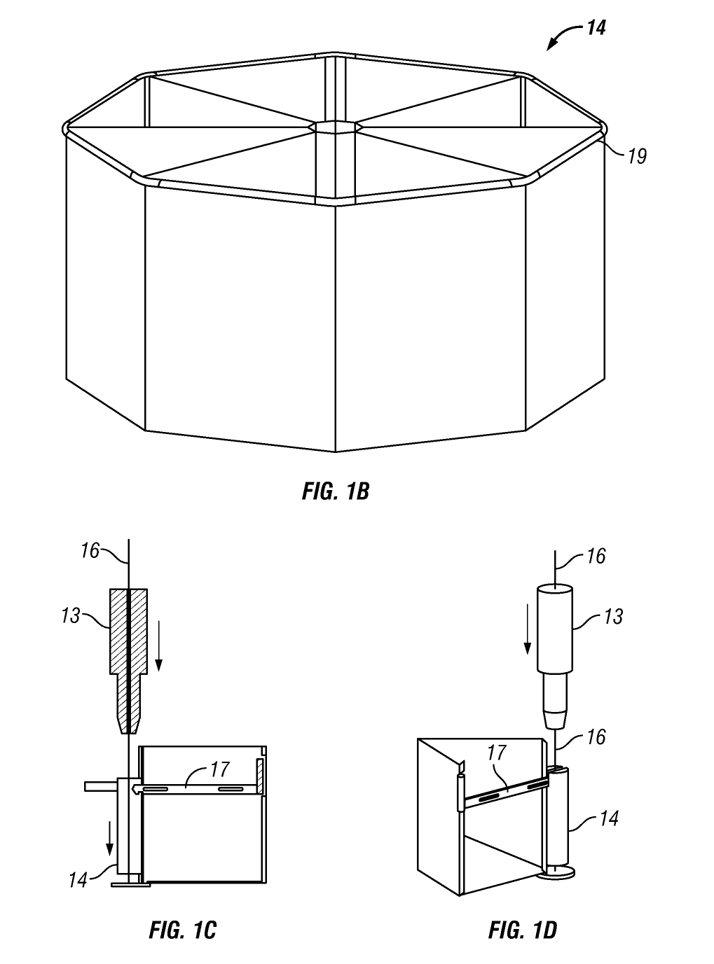

in one embodiment of the present invention, as illustrated in FIG. 1A, wave-driven pump 10 preferably comprises buoy 12 connected to valve 14 by cable 16 running inside of flexible tube 18. Buoy 12 preferably rides the waves of a large body of water, thus causing valve 14 to open and close. For the 3 m diameter pump described above, buoy 12 is necessarily quite large. The size, in fact, is dictated by the mass of water to be pumped up on each wave cycle. If the wave pump is operating efficiently in waves having a height of 3 m, the volume of water pumped on each wave stroke is (pi*r²*h*mass), or 21.2 m³. Assuming that buoy 12 has a displacement which is at least 2 times greater than the volume being pumped, a buoy with a volume of about 45 cubic meters is thus needed. If buoy 12 is cylindrical with a lengthwise dimension of 5 m, then the diameter is easily calculated to be 3.4 m.

In one embodiment, as illustrated in FIG. 1A methods and apparatuses are provided for installing fish echolocater 20 on buoy 12 of wave-driven pump 10, echolocater 20 is thus able to characterize the change in fish population around buoy 12 over time. While numerous echolocaters are known and can produce desirable results, a preferred echolocater is the Simrad SH80, or the companion model SX90.

The data generated by fish echolocater 20 can be periodically transmitted via a satellite link, thence to shore or boat-based computers for further processing and imaging of the fish population density, as well as any changes therein.

By disposing echolocater 20 on buoy 12 for numerous pumps 10 disposed in the ocean, rather than disposing echolocater on one or several boats, a near-continuous profile of local fish populations across wide areas of the open ocean greatly enhance the fishing boat's efficiency since it can proceed directly to locations with maximum population, thereby saving boat & crew cost, and reducing fuel consumption. In addition, echolocaters located on buoys rather than on boats, are afforded the ability to operate in a “quiet” environment, without interference from boat engines, propellers, onboard equipment etc., therefore the signal/noise ratio is greatly enhanced and the signal likely requires less post-processing to eliminate confusing signals. Still further, by disposing echolocaters 20 on buoys 12 from which is suspended cable 16 connected to valve 14 and flexible tube 18, when valve 14 is at a depth of several hundred meters, and tube 18 is extending vertically upward from the valve 14 a known distance, echolocater 20 can autocalibrate since the return signal from tube 18 and valve 14 are a constant, being known objects at known distances. This feature eliminates problems with boat-mounted echolocaters which are subjected to signal variability from different depths of the ocean floor as the boat travels across the ocean. Similarly, with boat-based echolocaters, the electronics comprising the transducer and transceiver can “drift” due to temperature and humidity effects, thereby requiring complex adjustments to provide usable information.

In a further embodiment of the present invention, the company or enterprise which deploys and/or operates the wave-driven pump buoys and associated hardware, may agree to rent space on buoy 12 for echolocater 20. The rental could be for a specified time period, and/or could include a fee for each transmission of data using communications capability provided onboard buoy 12. Alternatively or in addition, the enterprise could post-process the data and sell or otherwise make available data showing current fish populations as well as comparisons to previous time periods. Such information would not only be extremely useful for fishermen, but also be very helpful for fishery regulators in their quest to maintain sustainability of the resource.

A further embodiment of the present invention relates to an improved method for recovery of one or more pumps, for instance to service or replace valve 14 or other underwater component. Since tube 18 contains hundreds of tons of seawater, it is impractical to bring up valve 14 by winching it in, unless a method is devised to open valve 14 or otherwise release the water contained in tube 18. Several techniques to open valve 14, or to release the water in tube 18, are described below.

One technique is to provide a cable which runs from buoy 12 to valve 14, which cable can be exercised in a manner to open valve 14. This technique suffers from risk of the cable breaking over time, or inadvertently fouling valve 14. If constant tension is required to maintain valve 14 open, this also presents a problem especially in heavy sea states where the recovery boat and buoy 12 are moving up and down on different cycles.

Another technique is to electronically secure valve 14 in an open position. This can be done a number of different ways, for example with an acoustic release mechanism, or an explosive bolt.

A third, preferred technique, is to attach weight 13 at top of cable 16 which connects valve 14 to buoy 12. On command, weight 13 is released and slides down cable 16. When weight 13 impacts valve 14, releasing mechanism 15 is preferably shoved down, thus removing the catch on bar 17 such that it can slide to remove the tension from strap 19. Because strap 19 preferably holds flexible lube 18 to valve 14, when the tension is removed from strap 19, the water contained within flexible tube 18 can preferably drain therefrom when pump 10 is lifted out of the body of water. While the foregoing describes one specific example of how an opening can be provided for water to drain from pump 10 as pump 10 is removed from a body of water, various other methods, apparatuses, and systems can of course be provided to achieve the same result.

In one embodiment, a valve can be caused to operate in low wave conditions such as approximately 36″ wave heights. By providing a valve having multiple valve flappers with one or more cross-dimensions equal to the smallest wave amplitude desired for operation. As a practical matter, this dimension is approximately 18″, since a loss of about 50% in efficiency can be anticipated due to cable stretch, friction, and similar effects, thereby ensuring the valve will fully open and close in the aforementioned 36″ waves.

An embodiment of the present invention provides multiple sections of an injection molded unit with walls, valve flappers which snaps-on to a hinge rod, with each section joined to the adjacent section by a protrusions, and the entire assembly held together by a and securing straps.

While some embodiments of the present invention relate to wave driven upwelling pump apparatuses having a flexible tube for transportation of the water, alternative embodiments of the present invention eliminate the substantially vertical flexible tube, while simplifying the valve element, and reducing possible negative effects on the ocean environment from the artificial upwelling produced by the wave driven upwelling pump. This is accomplished by providing a plurality of valve assemblies disposed in a vertical column. A significant benefit of embodiments of the present invention relates to improved durability, a necessary condition for any apparatus to survive in the harsh open ocean environment.

In summary, these embodiments of the present invention comprises one or more rigid panels which are configured to move in an approximate 90 degree arc and which are attached to a cable. The cable and panels are disposed substantially vertically In a body of water, with one end of the cable attached to a buoy.

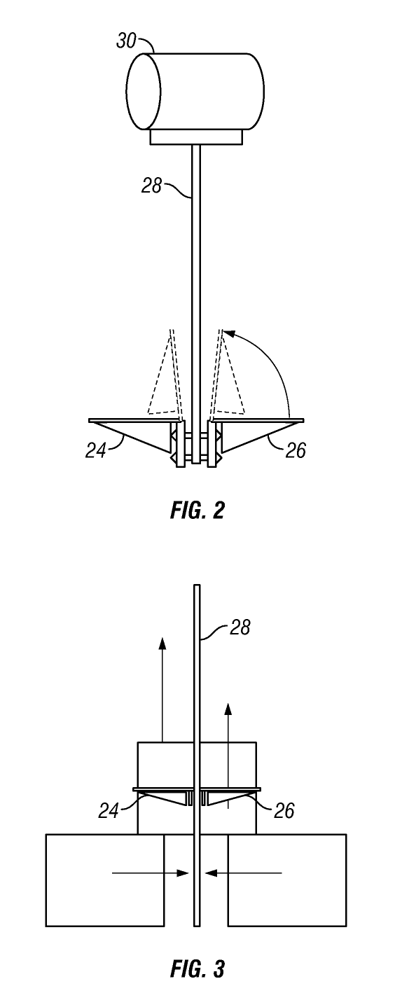

As illustrated in FIG. 2, in one embodiment of the present invention, two opposing rigid panels 24 and 26 are secured to cable 28 and are configured to rotate from horizontal to vertical positions, e.g., at 90 degrees with respect to cable 28, with hinge points 29 preferably located at the bottom of panels 24 and 26 when they are in a substantially vertical orientation.

In an embodiment of the present invention, buoy 30 rises and falls as waves move across the body of water. On the wave rising action, the water mass acts against panels 24 and 26 to move them into a substantially horizontal orientation. On the wave falling action, gravity causes buoy 30, panels 24 and 26, and cable 28 to move downward, producing a force from the water mass which moves panels 24 and 26 into a substantially vertical orientation.

Again referring to FIG. 2 with panels 24 and 26 attached to cable 28, when panels 24 and 26 are horizontal, and buoy 30 is moving upward from wave action, because water is incompressible, panels 24 and 26 move the water parcels contiguous to panels 24 and 26 in an upward direction. These contiguous parcels of water are more constrained by parcels of water positioned laterally from panels 24 and 26, than from more distant parcels above or below panels 24 and 26. Thus, the contiguous parcels are more likely to move in line with the direction of the buoy/cable/rigid panels than normal (laterally) to the in line direction. The volumetric space formerly occupied by the upwardly-moving contiguous water parcels is immediately occupied by laterally adjacent non-contiguous water parcels. See FIG. 3. This process develops a circular motion of non-contiguous water parcels.

As illustrated in FIG. 3, on wave down-slope, buoy 30, cable 28, and rigid panels 24 and 26 together fall toward the center of earth due to gravity. Because rigid panels 24 and 26 are operable in a 90 degree arc, the contiguous water parcels which have moved upward during the wave upslope, now act to rotate the downward-moving panels into a substantially vertical orientation. In this orientation, panels 24 and 26 offer much less resistance to the contiguous water parcels, and panels 24 and 26 readily move downward with cable 28, substantially equivalent to the movement downward of buoy 30 on the wave down-slope.

On the subsequent wave upslope, the contiguous water parcels rotate panels 24 and 26 into a horizontal orientation, further moving these water parcels upward. On the subsequent wave down-slope, the contiguous water parcels cause panels 24 and 26 to move from horizontal to vertical orientation, allowing contiguous as well as adjacent parcels of water to slide past the panels. Multiple waves thus produce an upwelling of the contiguous water parcels.

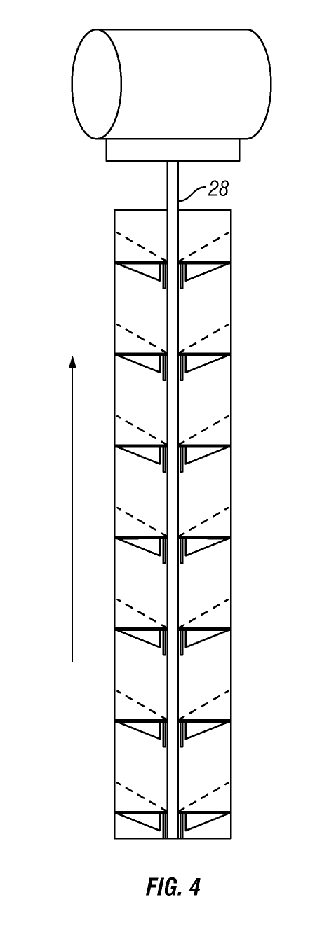

In further embodiments, multiple sets of panels can be affixed to cable 28 at appropriate spacing so that the upwelling flow becomes nearly continuous, as illustrated in FIG. 4. In this example, the multiple sets of panels one above the other, act in concert since contiguous water parcels are more constrained by parcels of water positioned laterally from the panels than from more distant parcels above or below the panels. In effect, the incompressibility of water forms a virtual tube that guides the contiguous water parcels upward since that is the path of least resistance to the moving panels and the moving contiguous water parcels.

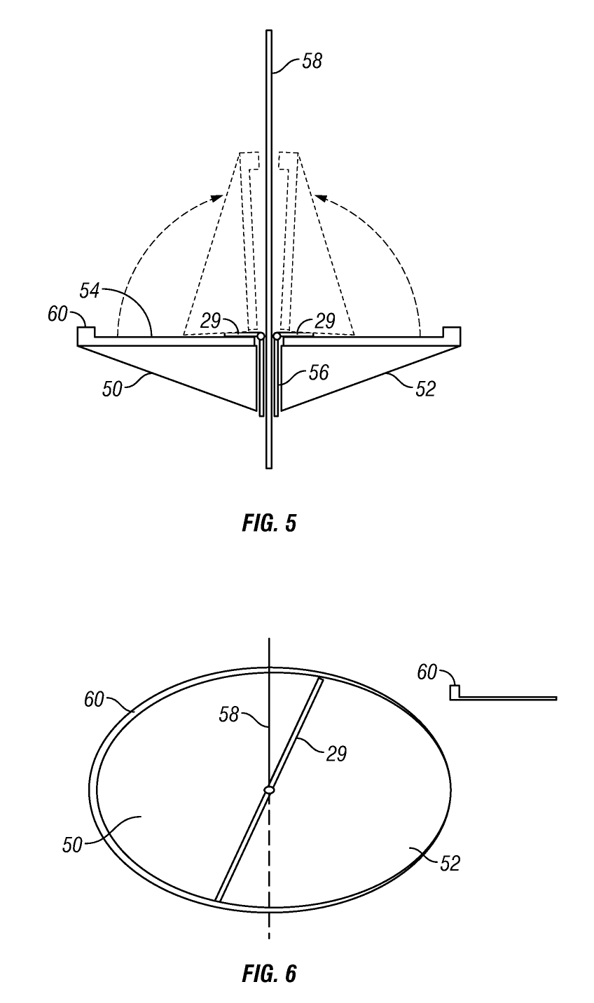

In a further embodiment of the present invention and as illustrated in FIG. 5, rotatable panels 50 and 52 are provided with structural member 54 that contacts second structural member 56 when panels 50 and 52 reach a horizontal orientation. As illustrated in FIG. 5, second structural member 56 is a rigid panel substantially parallel to cable 58 and possibly in contact with cable 58. These two structural members, 54 and 56 prevent panels 50 and 52 from rotating past the horizontal position. Cable 58 preferably acts as a structural member to prevent panels 50 and 52 from rotating past the vertical position.

In a further embodiment, illustrated in FIG. 6, the panel edge is provided with lip 60 which helps to contain the contiguous water parcel within the confines of the panel. Lip 60 can be of a dimension somewhat larger than the through-dimension of second structural member 56, thereby ensuring on wave down-slope that the panel is oriented somewhat off of vertical and provides a reaction surface on the edge of the panel, enabling the contiguous water to rotate the panel from near-vertical to horizontal.

In a related refinement, the bottom edge of the second structural member can assume an arc shape, thus reducing the water resistance against the edge, that otherwise could slow the downward motion of the panels on wave down slope.

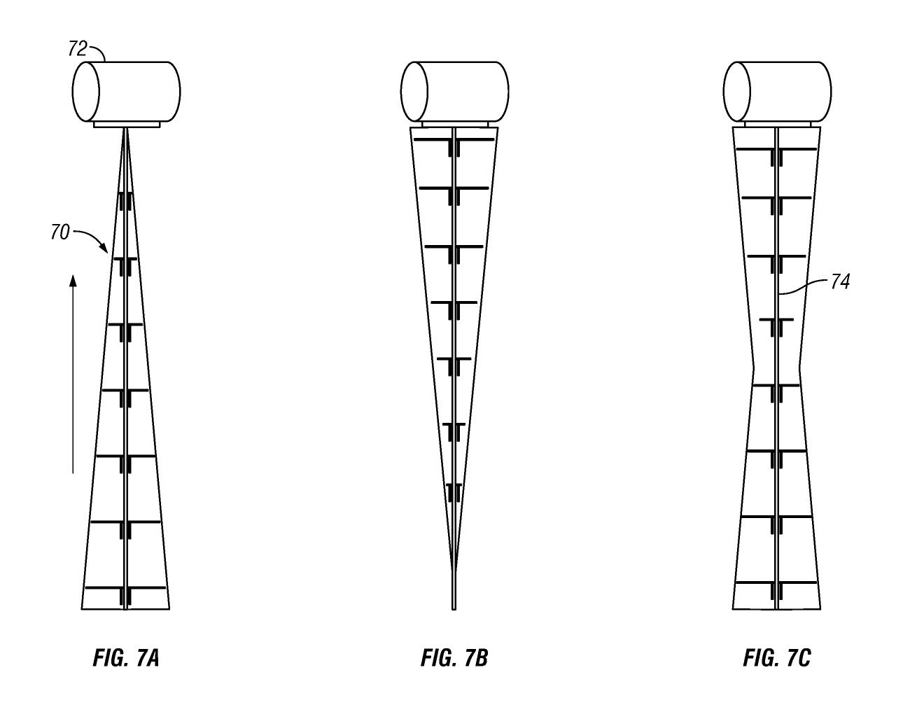

In a further embodiment of the invention, multiple sets of panels of different dimensions are provided on the cable. See FIGS. 7A to 7C. As illustrated in FIG. 7A, sets of panels 70 can become successively larger at greater distance from buoy 72. Since the deep ocean is denser, when brought upward the pump wants to sink back to its neutrally buoyant environment. This size progression allows less sinking of the denser water, since panels 70 have progressively larger surface area at greater depths. As illustrated in FIG. 7B, panels 74 can become successively smaller at greater distance from buoy 76, which will encourage more rapid sinking of the denser water. As a third design feature, and illustrated in FIG. 7C, comprises a blend of larger and smaller panels provided on cable 74, which for instance increases the mixing of contiguous and non-contiguous water parcels. Enhanced mixing preferably breaks down greater stratification of the ocean, which scientists attribute to global warming.

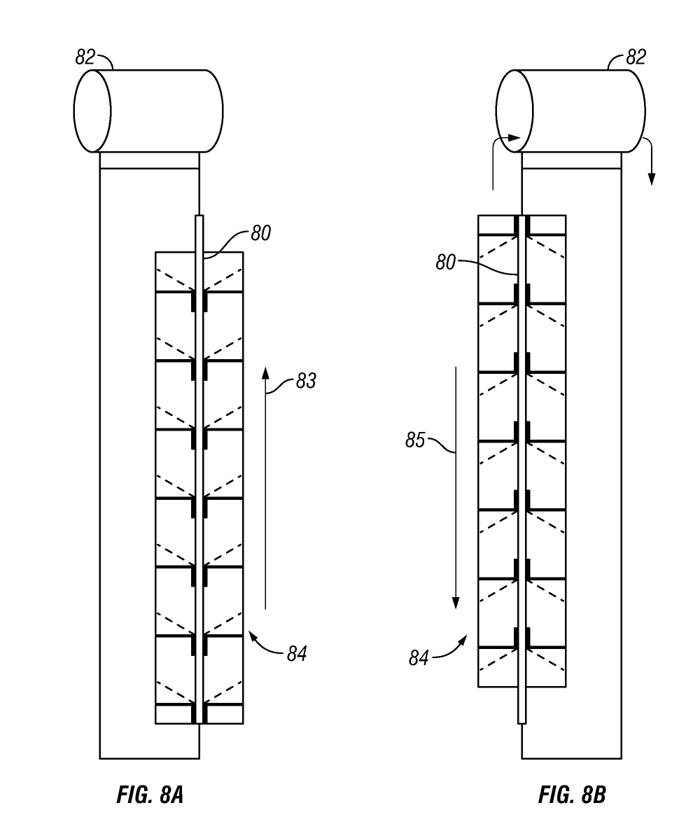

Referring to FIGS. 8A and 8B, in a further embodiment of the invention, cable 80 is made into a continuous loop, preferably, although not necessarily, connected to buoy 82 at opposite ends, with sets of panels 84 provided one above the next on some portion of the continuous cable loop. When all the panels are on one vertical segment of the cable loop, and with each panel hinge point at the bottom edge when oriented vertically, upwelling 83 is achieved, since panels 84 are oriented horizontally on wave upslope, and vertically on wave down-slope. To invert the process from upwelling 83 to downwelling 85, the portion of the loop cable previously adjacent buoy 82 connection point, is moved to the bottom of the loop, and panels 84 move with cable 80 until they are oppositely oriented. The hinge point about which panels 84 rotate is now inverted with respect to cable 80, so that panels 84 are vertical on wave upslope and horizontal on wave down-slope. The weight of panels 84 and cable 80 will drop due to gravity, generating downwelling 85. See FIGS. 8A and 8B.

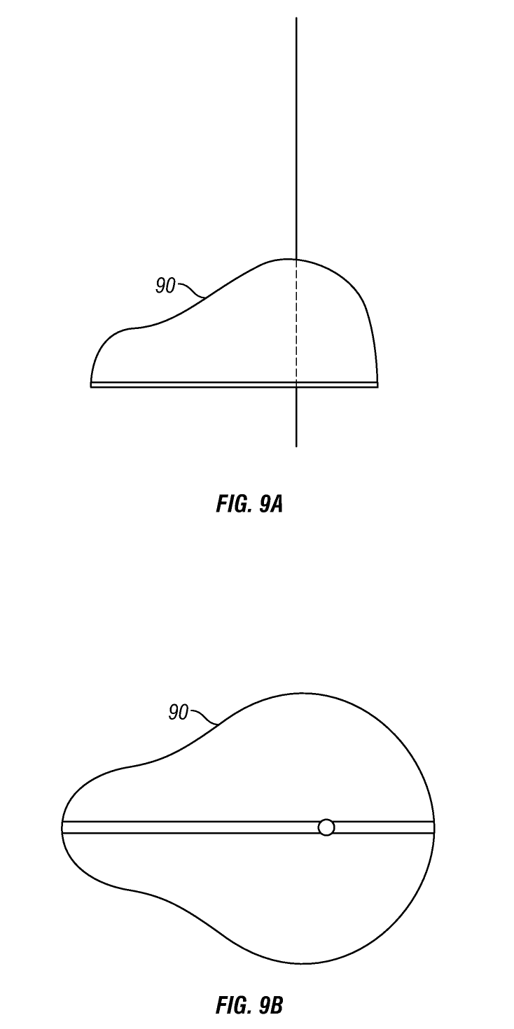

In a further refinement of the present invention, each set of panels can be provided with ellipsoidal shape 90 (when viewed from above), so that when in a vertical position, any lateral ocean currents rotate the panels in line with the currents, much like a weathervane, to reduce oscillation of the panels and maximize the sinking of the panels and cable, by gravity, during the wave down-slope. Ellipsoidal shape 90 offers maximum surface area with an offset center of force, allowing the panel to rotate in line with lateral currents. Otherwise, lateral currents could act against the downward-falling panel to cause oscillation, possibly reducing the wave down-slope efficiency. See FIGS. 9A and 9B.

As with the previous inventions, many pumps can be connected laterally one to the next, to form arrays of pumps, or the pumps can be deployed in free-drifting manner in the open ocean.

While the benefits and applications of the wave driven upwelling pump and system previously cited remain in effect, further information provided below is now available to buttress the utility of the invention.

The embodiments of the present invention offer natural upwelling, since the deep water is moved upward incrementally rather than all at once. Taking an example of a 300 m deep upwelling pump, in the prior inventions, the water parcels are moved inside the flexible tube up to the surface, without intermediate mixing. This could represent a shock to the upper ecosystem, using as an example the much colder temperature of the deep water—perhaps 5 to 10 degrees C.—arriving en masse in the surface waters measuring perhaps 25 degrees C.

In the present application, the virtual tube design allows some intermediate mixing as the contiguous water parcels move upward, presenting much less instantaneous change upon arriving at the surface.

The present application offers multiple sets of rotating panels (equivalent to the valve flappers in the prior filings), greatly reducing risk of failure since the upwelling action is likely to occur even if some of the panels cease to operate.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A method for increasing fish populations comprising:
providing a wave-driven pump; and
pumping water with the wave-driven pump to bring locally-existing nutrients from a deeper layer to an upper layer.

2. The method of claim 1 wherein the pumping occurs within a large body of water.

3. The method of claim 2 wherein the large body of water comprises the ocean.

4. The method of claim 1 wherein the water is pumped a distance of at least 100 feet.

5. The method of claim 1 wherein the water is pumped a distance of at least 600 feet.

6. The method of claim 1 further comprising monitoring fish populations around at least an upper portion of the pump using an echolocater.

7. The method of claim 6 wherein the echolocater is disposed on a portion of the pump.

8. The method of claim 6 wherein the echoloacter is disposed on the buoy of the pump.

9. A method of claim 6 further comprising communicating results of the fish monitoring to a remote location.

10. A wave-driven pump comprising a releasable valve disposed at a lower portion thereof.

11. The wave-driven pump of claim 10 wherein said valve is released by a weight sliding down a cable and impacting a portion of said valve.

12. The wave-driven pump of claim 11 wherein said weight impacts a release mechanism of said valve.

13. The wave-driven pump of claim 10 wherein said valve comprises an assembly which provides a breach within the pump whereby water is releasable through said breach when said pump is lifted from a body of water.

14. The wave-driven pump of claim 13 wherein said assembly comprises an impact-activated release mechanism.

15. An ocean water movement apparatus comprising a plurality of rotatable panels connected to a wave energy capturing apparatus by a cable.

16. The apparatus of claim 15 wherein said energy capturing apparatus comprises a buoy.

17. The apparatus of claim 15 wherein at least some of said rotatable panels are arranged in pairs and disposed along at least a portion of said cable at spaced intervals.

18. The apparatus of claim 15 wherein the panels are positioned on said cable such that a primary axis of said cable forms a substantially right angle with a primary plane of said panels when said panels are in a non-rotated state.

19. The apparatus of claim 18 wherein said panels rotate approximately 90 degrees such that a primary axis of said cable is substantially parallel with a primary plane of said panels when said panels are in a rotated state.

20. The apparatus of claim 15 wherein water parcels not contiguous to said rotatable panels constrain the movement of water parcels contiguous to the rotatable panels.

21. The apparatus of claim 20 wherein water movement of the contiguous parcels is substantially vertical.

22. The apparatus of claim 15 further comprising a cable formed into a loop which is connected to said wave energy capturing device.

23. The apparatus of claim 22 wherein a topmost portion of said cable loop is movably positionable.
